(19) United States
(12) Patent Application Publication
(10) Pub. No.: US 2012/0291994 A1
(43) Pub. Date: Nov. 22, 2012

(54) AIR CONDITIONING MODULES

(75) Inventors: Michael AINLEY, Derby (GB); Andrew GASKELL, Derby (GB)

(73) Assignee: Frenger Systems Limited, Derby (GB)

(21) Appl. No.: 13/475,070

(22) Filed: May 18, 2012

(30) Foreign Application Priority Data
May 20, 2011 (GB) 1108469.6

(51) Int. Cl. F28D 15/00; B23P 19/04

(52) U.S. Cl. 165/104.11; 29/428

(57) ABSTRACT

An air conditioning module, for location adjacent a ceiling surface, includes a heat exchanger which has an upstream side to receive incoming air and a downstream side to discharge conditioned air and also includes a primary air chamber that is arranged in fluid communication with the downstream side of the heat exchanger and is spaced from the heat exchanger to define a discharge chamber that lies between the primary air chamber and the heat exchanger. The air conditioning module includes a heat exchanger cover which extends over the upstream side of the heat exchanger to define an inlet and further includes a discrete inlet barrier that is separately formed from the heat exchanger cover and is coupled between the heat exchanger cover and the heat exchanger to inhibit the direct passage of incoming air from the inlet to the discharge chamber

This invention relates to an air conditioning module and a method of installing an air-conditioning module.

Conventional air conditioning modules are often either integrated within a ceiling structure such that their discharge outlets lie coincident with the exposed surface of the ceiling structure, or are suspended from a ceiling structure so as to lie immediately below the exposed ceiling surface.

Such existing air conditioning modules demonstrate less than ideal efficiency.

There is, therefore, a need for an improved air conditioning module which obviates the aforementioned drawback.

According to an aspect of the invention there is provided an air conditioning module, for location adjacent a ceiling surface, comprising:
a heat exchanger having an upstream side to receive incoming air and a downstream side to discharge conditioned air;
a primary air chamber arranged in fluid communication with the downstream side of the heat exchanger and spaced from the heat exchanger to define a discharge chamber lying between the primary air chamber and the heat exchanger;
a heat exchanger cover extending over the upstream side of the heat exchanger to define an inlet; and
a discrete inlet barrier separately formed from the heat exchanger cover and coupled between the heat exchanger cover and the heat exchanger to inhibit the direct passage of incoming air from the inlet to the discharge chamber, the inlet barrier including an engagement formation to mechanically secure the inlet barrier to the heat exchanger.

The provision of a discrete inlet barrier allows the heat exchanger cover to be assembled into the air conditioning module with ease and flexibility, while improving the efficiency at which the air conditioning module operates by minimising the extent to which incoming air is able to bypass the heat exchanger.

In addition, the provision of an engagement formation to mechanically secure the inlet barrier to the heat exchanger allows the inlet barrier to itself provide a reliable support to hold the heat exchanger cover relative to the heat exchanger.

Optionally the engagement formation defines a first hook formation that in use suspends the inlet barrier from the heat exchanger. The inclusion of a first hook formation simplifies assembly of the air conditioning module still further, and assists in positioning the heat exchanger cover relative to the heat exchanger.

The engagement formation may be mechanically fixed to the heat exchanger. Mechanically fixing the engagement formation to the heat exchanger, e.g. by screws, nuts and bolts, or welding, assists in supporting the heat exchanger cover along its length and so helps to avoid unsightly sagging of the cover relative to the remainder of the air conditioning module.

Preferably the engagement formation defines a curved profile which lies adjacent to a downstream side of the heat exchanger. Such an arrangement presents a smooth surface to conditioned air leaving the heat exchanger, and so reduces the friction acting upon such air, which in turn helps to improve the efficiency of the air conditioning module.

Optionally the curved profile extends into the discharge chamber. Having the curved profile extend into the discharge chamber improves the stability of the primary air and conditioned air mixture moving within the discharge chamber, which helps to improve the overall efficiency of the air conditioning module.

The inlet barrier and the heat exchanger cover may include mutually cooperable formations to join one to the other. Such mutually cooperable formations assist during assembly in ensuring the inlet barrier is positioned correctly relative to the heat exchanger cover.

In a preferred embodiment of the invention the inlet barrier includes a mutually cooperable formation in the form of a second hook formation from which the heat exchanger cover is in use suspended. Such a second hook formation allows the heat exchanger cover to be easily separated from the inlet barrier, and hence readily removed from the air conditioning module, e.g. for repair and/or maintenance purposes.

Preferably the inlet barrier is formed from a single extrusion. Such an arrangement simplifies both the manufacturing and assembly processes.

Optionally the inlet barrier is resiliently biased between the heat exchanger cover and the heat exchanger. Such an arrangement facilitates integration of the inlet barrier into the air conditioning module without the need for specialist tools or additional fasteners.

According to a further aspect of the invention there is provided a method of installing an air conditioning module adjacent a ceiling surface, the air conditioning module including a heat exchanger having an upstream side to receive incoming air and a downstream side to discharge conditioned air, a primary air chamber arranged in fluid communication with the downstream side of the heat exchanger and spaced from the heat exchanger to define a discharge chamber lying between the primary air chamber and the heat exchanger, and a heat exchanger cover extending over the upstream side of the heat exchanger to define an inlet, the method comprising the step of:
coupling a discrete inlet barrier separately formed from the heat exchanger cover between the heat exchanger cover and the heat exchanger to inhibit the direct passage of incoming air from the inlet to the discharge chamber, the inlet barrier including an engagement formation to mechanically secure the inlet barrier to the heat exchanger.

The foregoing method shares the advantages of the associated air conditioning module.

There now follows a brief description of preferred embodiments of the invention, by way of non-limiting example, with reference being made to the accompanying drawings in which:

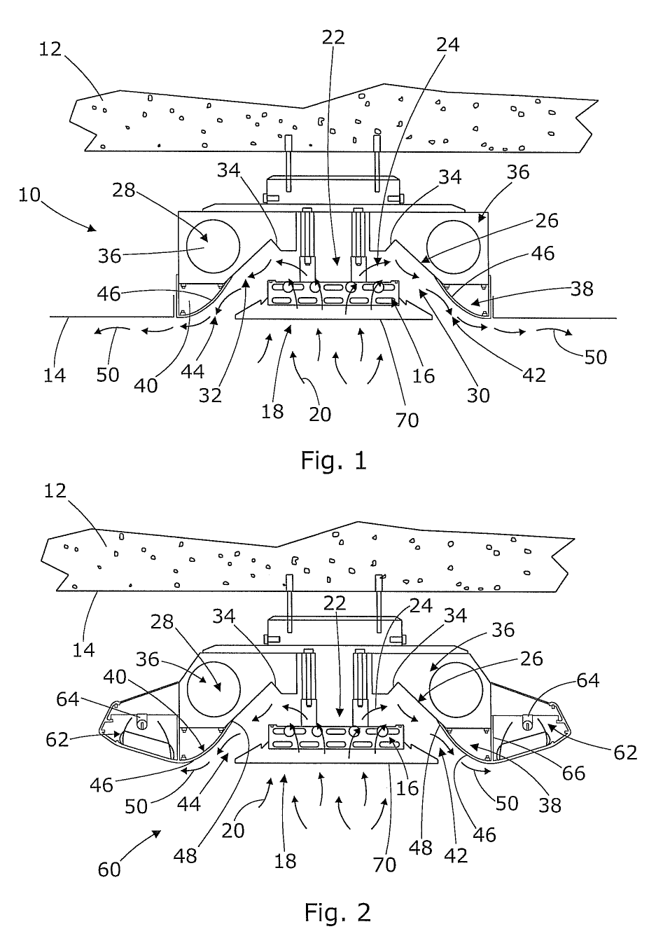

FIG. 1 shows an air conditioning module according to a first embodiment of the invention;

FIG. 2 shows an air conditioning module according to a second embodiment of the invention;

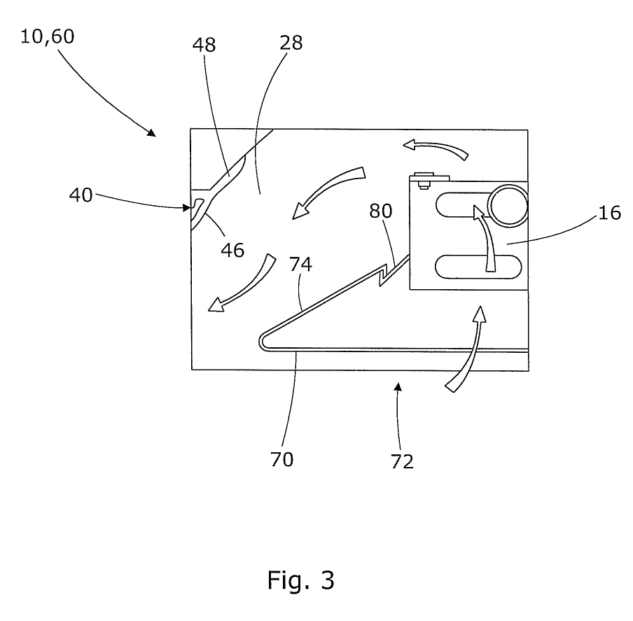

FIG. 3 shows a first inlet barrier in an enlarged portion of the air conditioning modules shown in each of FIGS. 1 and 2;

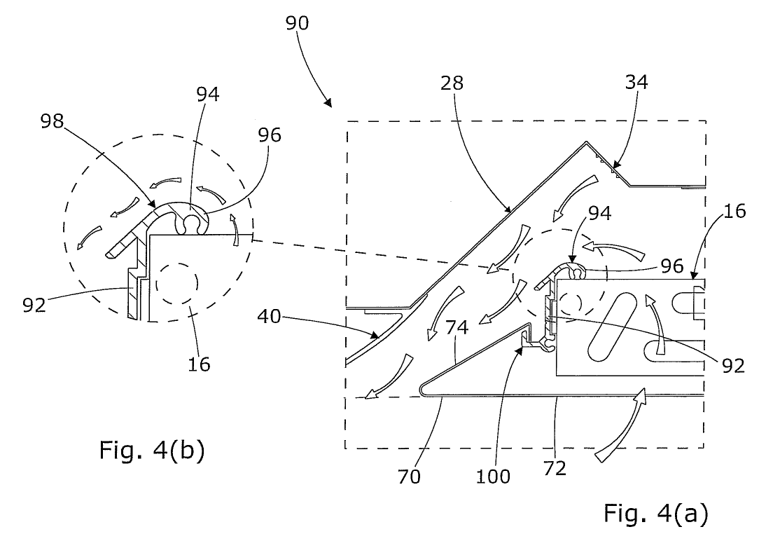

FIG. 4(a) shows a second inlet barrier in an enlarged portion of a further air conditioning module; and

FIG. 4(b) shows a further enlarged portion of FIG. 4(a).

An air conditioning module according to a first embodiment of the invention is designated generally by the reference numeral 10.

The air conditioning mod ule 10 is shown integrated within a ceiling structure 12 such that it lies coincident with an exposed ceiling surface 14 of the ceiling structure 12.

The air conditioning module 10 includes a heat exchanger 16 that has an upstream side 18 to receive incoming air 20 and a downstream side 22 to discharge conditioned air 24.

The module 10 also includes first and second primary air chambers 26, 28. Other embodiments of the invention (not shown) may include only a single primary air chamber.

Each primary air chamber 26, 28 is arranged in fluid communication with the downstream side 22 of the heat exchanger 16 and is spaced from the heat exchanger 16 to define respective first and second discharge chambers 30, 32 which lie between the given primary air chamber 26, 28 and the heat exchanger 16. Each primary air chamber 26, 28 includes a plurality of primary air discharge ports 34 to direct primary air 36, i.e. pressurised air from a separate source such as an air handling unit or a supply fan, into the corresponding discharge chamber 30, 32.

In the embodiment shown each of the primary air discharge ports 34 is in the form of a discharge slot. The or each discharge port 34 may also take the form of a discharge nozzle.

In addition the air conditioning module 10 includes first and second discrete outlet members 38, 40 each of which is separately formed from the corresponding primary air chamber 26, 28 to which it is fixedly secured.

Each outlet member 38, 40 defines a portion of a respective first and second discharge outlet 42, 44 which is arranged in fluid communication with the corresponding first or second discharge chamber 30, 32.

In particular, each outlet member 38, 40 includes a curved surface 46 which defines the portion of the corresponding discharge outlet 42, 44. In each instance the curved surface 46 is defined by a single curved profile.

Each outlet member 38, 40 additionally includes an overlap portion 48 that extends over the primary air chamber 26, 28 to which the outlet member 38, 40 is fixedly secured.

In the embodiment shown each outlet member 38, 40 is integrally formed from a single extrusion which has a desired cross-sectional profile and includes the curved surface 46.

In use each outlet member 38, 40 presents its curved surface 46 to a mixture of primary air 36 and conditioned air 24 that is moving in the associated discharge chamber 30, 32. Each curved surface 46 entrains the air mixture 50 against the corresponding outlet member 38, 40 and in this way directs the air mixture 50 along the ceiling surface 14, as desired.

An air conditioning module 60 according to a second embodiment of the invention is shown in FIG. 2.

The second air conditioning module 60 is similar to the first air conditioning module 10 and like features share the same reference numeral.

The second air conditioning module 60 is shown suspended from a ceiling structure 12 such that it lies immediately below an exposed ceiling surface 14.

The second air conditioning module 60 differs from the first air conditioning module 10 in that each outlet member 38, 40 includes a service chamber 62 coupled therewith. In the embodiment shown the service chamber 62 includes lighting services in the form of a plurality of lighting elements 64. In other embodiments of the invention the or each service chamber 62 may include a different service element such as an additional heating or cooling element.

Furthermore, in the second air conditioning module 60 each outlet member 38, 40 is formed from a plurality of extrusion elements 66 that are cooperable with one another to define a desired overall cross-sectional profile. In the embodiment shown the extrusion elements 66 are slidably coupled to one another. In other embodiments of the invention (not shown) each outlet member 38, 40 the extrusion elements 66 may interlock with one another or be mechanically fastened to one another. In still further embodiments of the invention (not shown) each outlet member 38, 40 may be formed from a single extruded profile which also defines the associated service chamber 62.

Each of the first and second air conditioning modules 10; 60 includes a heat exchanger cover 70 that extends over the upstream side 18 of the heat exchanger to define an inlet 72. Such an inlet 72 may be formed by a plurality of perforations in the heat exchanger cover 70.

Each heat exchanger cover 70 includes first and second wing members 74, 76 each of which defines both a portion of the inlet 72 and another portion of the respective discharge outlet 42, 44 that it forms a part of.

Each first and second air conditioning module 10; 60 further includes a pair of first discrete inlet barriers 78, 80, each of which is separately formed from the heat exchanger cover 70. Each first inlet barrier 78, 80 is coupled between a respective wing member 74, 76 and the heat exchanger 16, as shown in FIG. 3 (only one first inlet barrier 80 is shown in FIG. 3) .

Each first inlet barrier 78, 80 is mechanical fixed between the heat exchanger cover 70 and the heat exchanger 16. In particular each first inlet barrier 78, 80 is mechanically fixed to the heat exchanger, e.g. by screws, nuts and bolts, or welding, and the heat exchanger cover 70 hooks onto the respective first inlet barrier 78, 80. As a result the heat exchanger cover 70 is easy to install and remove for maintenance purposes.

Each first inlet barrier 78, 80 and the corresponding wing member 74, 76 include mutually cooperable formations to join one to the other, i.e. to allow the heat exchanger cover 70 to hook onto the frist inlet barriers 78, 80, and also assist with the alignment of each first inlet barrier 78, 80 with the corresponding wing member 74, 76.

In use each first inlet barrier 78, 80 inhibits the direct passage of incoming air 20 from the inlet 72 to a respective discharge chamber 42, 44, and so minimises the extent to which incoming air 20 is able to bypass the heat exchanger 16.

FIG. 4(a) shows an enlarged portion of a further air conditioning module 90 in which is included a second inlet barrier 92. The further air conditioning module 90 is similar to each of the first and second air conditioning modules 10; 60, and like features share the same reference numerals. The further air conditioning module 90 includes two such second inlet barriers 92, one on either side of the heat exchanger 16, although only one second inlet barrier 92 is shown in FIG. 4(a).

The second inlet barrier 92 includes an engagement formation 94 to mechanically secure the second inlet barrier 92 to the heat exchanger 16. In the embodiment shown the engagement formation defines a first hook formation 96 which in use suspends the second inlet barrier 92 from the heat exchanger 16.

In other embodiments of the invention (not shown) the engagement formation 94 may be mechanically fixed, e.g. by screws, nuts and bolts, or welding, to the heat exchanger 16.

The engagement formation shown defines a curved profile 98 which lies adjacent to the downstream side 22 of the heat exchanger 16. The curved profile 98 also extends into the corresponding discharge chamber 30, 32, as illustrated schematically in FIG. 4(b).

The second inlet barrier 92 and the heat exchanger cover 70 include mutually cooperable formations to join one to the other. More particularly the second inlet barrier 92 includes a mutually cooperable formation in the form of a second hook formation 100 from which a corresponding wing member 74, 76 is in use suspended.

The illustrated second inlet member 92 is formed from a single extrusion, although this need not be the case in all embodiments of the invention. In the embodiment shown the second inlet member 92 also extends substantially along the whole length of the heat exchanger 16.

1. An air conditioning module, for location adjacent a ceiling surface, comprising:
a heat exchanger having an upstream side to receive incoming air and a downstream side to discharge conditioned air;
a primary air chamber arranged in fluid communication with the downstream side of the heat exchanger and spaced from the heat exchanger to define a discharge chamber lying between the primary air chamber and the heat exchanger;
a heat exchanger cover extending over the upstream side of the heat exchanger to define an inlet; and
discrete inlet barrier separately formed from the heat exchanger cover and coupled between the heat exchanger cover and the heat exchanger to inhibit the direct passage of incoming air from the inlet to the discharge chamber, the inlet barrier including an engagement formation to mechanically secure the inlet barrier to the heat exchanger.

2. An air conditioning module according to claim 1 wherein the engagement formation defines a first hook formation that in use suspends the inlet barrier from the heat exchanger.

3. An air conditioning module according to claim 1 wherein the engagement formation is mechanically fixed to the heat exchanger.

4. An air conditioning module according to claim 1 wherein the engagement formation defines a curved profile which lies adjacent to a downstream side of the heat exchanger.

5. An air conditioning module according to claim 4 wherein the curved profile extends into the discharge chamber.

6. An air conditioning module according to claim 1 wherein the inlet barrier and the heat exchanger cover include mutually cooperable formations to join one to the other.

7. An air conditioning module according to claim 6 wherein the inlet barrier includes a mutually cooperable formation in the form of a second hook formation from which the heat exchanger cover is in use suspended.

8. An air conditioning module according to claim 1 wherein the inlet barrier is formed from a single extrusion.

9. An air conditioning module according to claim 1 wherein the inlet barrier is resiliently biased between the heat exchanger cover and the heat exchanger.

10. A method of installing an air conditioning module adjacent a ceiling surface, the air conditioning module including a heat exchanger having an upstream side to receive incoming air and a downstream side to discharge conditioned air, a primary air chamber arranged in fluid communication with the downstream side of the heat exchanger and spaced from the heat exchanger to define a discharge chamber lying between the primary air chamber and the heat exchanger, and a heat exchanger cover extending over the upstream side of the heat exchanger to define an inlet, the method comprising the step of:
coupling a discrete inlet barrier separately formed from the heat exchanger cover between the heat exchanger cover and the heat exchanger to inhibit the direct passage of incoming air from the inlet to the discharge chamber, the inlet barrier including an engagement formation to mechanically secure the inlet barrier to the heat exchanger.

11-12. (canceled)
